(19) United States
(12) Patent Application Publication
(10) Pub. No.: US 2015/0145740 A1
(43) Pub. Date: May 28, 2015

(54) Integrated Frequency Multiplier and Slot Antenna

(71) Applicant: LSI Corporation, San Jose, CA (US)

(72) Inventors: Roger A. Fratti, Mohnton, PA (US); Albert Torressen, Bronx, NY (US); James R. McDaniel, Nazareth, PA (US); Scott W. McLellan, Kempton, PA (US)

(73) Assignee: LSI Corporation, San Jose, CA (US)

(21) Appl. No.: 14/132,881

(22) Filed: Dec. 18, 2013

Related U.S. Application Data
(60) Provisional application No. 61/908,914, filed on Nov. 26, 2013.

(51) Int. Cl. H01Q 13/10; H01Q 19/00; H01G 13/00

(52) U.S. Cl. CPC H01Q 13/10; H01G 13/006; H01Q 19/00
USPC 343/767; 29/25.42

(57) ABSTRACT

A metal substrate with a slot therein forms a slot antenna, the slot having a major axis and a minor axis. A dielectric layer has a plurality of terminals disposed on or in the dielectric layer and the layer is attached on one surface of the substrate. The terminals of a non-linear device, such as a diode, are connected to corresponding terminals of the dielectric layer. The non-linear device is positioned proximate the slot and is substantially aligned with a minor axis of the slot. A transmission line feeds an RF signal to the non-linear device that in turn frequency multiplies the RF signal to an RF signal that is radiated by the slot antenna. The dielectric layer is positioned in the slot such that the radiated RF signal has a desired output power. A protective layer is applied to the other surface of the substrate to cover the slot.

### CROSS-REFERENCE TO RELATED APPLICATIONS

This application claims the benefit of the filing date of U.S. Provisional Patent Application Ser. No. 61/908,914, filed on 26 Nov. 2013, the teachings of which are incorporated herein in its entirety by reference.

### BACKGROUND

1. Field of the Invention

The present invention relates to antenna systems generally and, more specifically, to a combined frequency multiplier and slot antenna.

2. Description of the Related Art

Very short range communication systems are being touted for low power, secure communications, particularly in battery operated portable equipment. Previous attempts with near-field communications have been less than satisfactory due to the relatively large wire coil or loop antennas that are required for operation at typical industrial/scientific/manufacturing (ISM) frequency allocations, e.g., 13.56 MHz. Moreover, these relatively low frequencies cannot communicate at the multi-megabit datarates needed for many applications in use today, e.g., mobile-to-mobile file transfers. Bluetooth transceivers are low power and can handle high-speed data transfer but they are subject to eavesdropping due to the 10+ meter communications distances that Bluetooth transceivers can communicate.

One technique for providing very short-range, high datarate communication is to transmit at frequencies that have a high enviromental absorption rate and operate at low power. For example, the 60/61 GHz ISM band is subject to relatively high levels of absorption (several dB/km) by molecular oxygen. Thus, using a low power transmitter at these frequencies, a maximum communication distance of less than a few meters is possible with a low probability of intercept by an eavesdropping receiver that is more than this distance from the transmitter.

Generating any significant power at these frequencies is problematic with low cost silicon-based complementary metal-oxide-semiconductor (CMOS) processes. Higher performance silicon-germanium (SiGe) and gallium arsenide (GaAs) semiconductor technologies are typically unable to operate at frequencies greater than 20 or 30 GHz. Indium phosphide transistors are capable of doing so but fabricating these devices is expensive and integrating them into silicon-based devices is difficult. Thus, it is desirable to provide an expensive, low power transmitter operable in the 60/61 GHz band that utilizes silicon-based devices such as low cost CMOS devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The drawings are not to scale.

In one embodiment of the invention, a conducting substrate and a non-linear device are provided. The substrate, having a first major surface and a second major surface, has a slot formed therein, the slot having a major axis and a minor axis. The non-linear device has two terminals and those terminals are coupled between opposing edges of the slot on the first major surface and aligned with the minor axis.

### BRIEF DESCRIPTION OF THE DRAWINGS

Other embodiments of the present invention will become more fully apparent from the following detailed description, the appended claims, and the accompanying drawings in which like reference numerals identify similar or identical elements.

FIG. 1 is a simplified diagram of a slot antenna with a frequency multiplier integrated therewith, according to an embodiment of the invention;

FIG. 2 is a cross-sectional view of the integrated slot antenna/frequency multiplier along lines A-A of FIG. 1;

FIG. 3 is a diagram showing the constitute parts of the integrated antenna/frequency multiplier shown in FIG. 1;

FIG. 4 is a cross-sectional view of an integrated slot antenna/frequency multiplier, according to another embodiment of the invention;

FIG. 5 is an exemplary process for forming the integrated slot antenna/frequency multiplier, and,

FIG. 6 is an exemplary application of the integrated slot antenna/frequency multiplier.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation”.

It should be understood that the steps of the exemplary methods set forth herein are not necessarily required to be performed in the order described, and the order of the steps of such methods should be understood to be merely exemplary. Likewise, additional steps might be included in such methods, and certain steps might be omitted or combined, in methods consistent with various embodiments of the present invention.

Also for purposes of this description, the terms “couple”, “coupling”, “coupled”, “connect”, “connecting”, or “connected” refer to any manner known in the art or later developed in which energy is allowed to transfer between two or more elements, and the interposition of one or more additional elements is contemplated, although not required. Conversely, the terms “directly coupled”, “directly connected”, etc., imply the absence of such additional elements. Signals and corresponding nodes or ports might be referred to by the same name and are interchangeable for purposes here. The term “or” should be interpreted as inclusive unless stated otherwise.

The present invention will be described herein in the context of illustrative embodiments of an slot antenna with an integrated frequency multiplier adapted for use in a portable apparatus, such as a wireless terminal, or the like. It is to be appreciated, however, that the invention is not limited to the specific apparatus and methods illustratively shown and described herein.

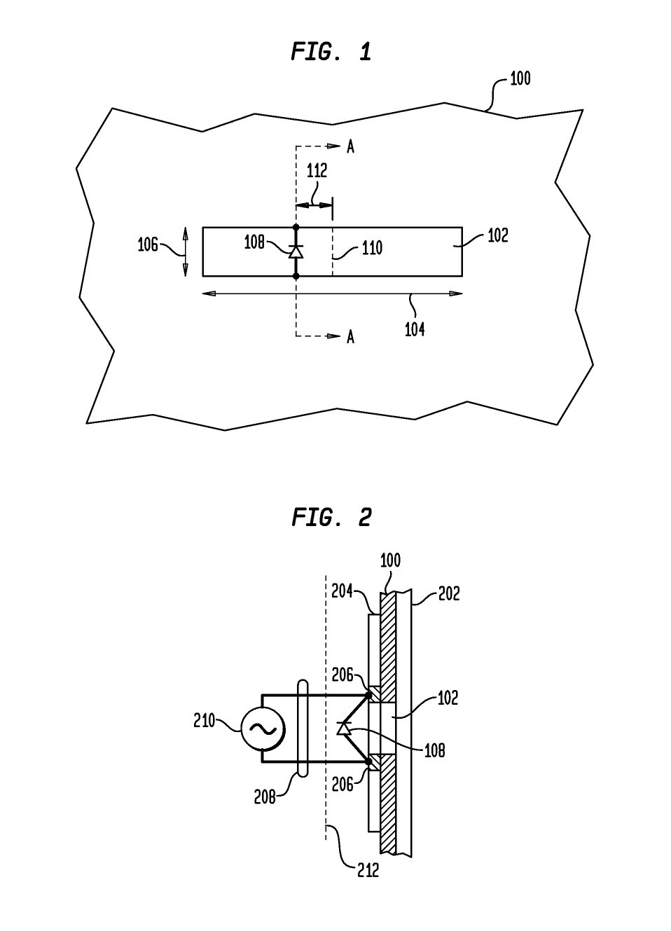

FIG. 1 is a block diagram of an exemplary slot antenna integrated with a frequency multiplier. A conductive, e.g., copper or copper-plated, substrate 100 has a slot 102 conventionally cut therein. The slot 102 has major axis 104 and a minor axis 106. The slot 102 preferrably has a length along its major axis of approximately odd multiples of half wavelength of a radio frequency signal to be radiated by the slot 102, i.e., N(λ/2), where N=1, 3, 5, etc. The slot 102 has a length along its minor axis that is generally a fraction of the length of the major axis and might be determined based on the desired bandwidth of the slot antenna and the desired far-field radiation pattern of slot antenna. In one embodiment, the length of the slot 102 along its minor axis is approximately the length of the non-linear device 108 used, as will be described in more detail below, to generate a harmonic signal (by frequency multiplication) from a radio frequency excitation signal applied thereto.

The non-linear device 108 is positioned along the slot 102 to achieve the desired output power from the slot antenna. Generally, the greatest output will occur when the device 108 is displaced from center line or midpoint 110 of the slot along its major axis, the amount of displacement or offset 112 might be dependent on the characteristics of the device 108 and the length of the slot 102 along the minor axis 106. In one embodiment, the non-linear device 108 has two leads or terminals, both of which are electrically connected (through bonding, soldering, welding, etc.) to opposite sides of the slot as shown, here on opposite sides of the slot 102 and aligned with the minor axis 106 of the slot 102. Thus, the length of the slot 102 along its minor axis is approximately equal to the length of the device 108 but might be larger or smaller. In an alternative embodiment discussed in more detail below in connection with FIG. 4, the device 108 is not electrically connected along the sides of the slot 102.

The non-linear device 108 is chosen to generate radio frequency signals at multiples of the RF signal applied to it. Some devices, such as a gallium arsenide or indium phosphide junction diode or Schottky diode (sometimes referred to as a metal-semiconductor diode or hot-carrier diode) might be relatively efficient in generating even order harmonic signal, whereas anti-parallel diodes (i.e., two or more diodes connected in parallel with cathodes connected to anodes) might be relatively efficient in generating an odd order harmonic signal. Alternatively, one or more PIN diodes (diodes formed from p-type and n-type semiconductor with an undoped (insulating) semiconductor region therebetween) or one or more step-recovery diodes might be used for the non-linear device 108 depending upon the frequency of use, the desired output power, and the amount of frequency multiplication required. Alternatively, the non-linear device 108 might be implemented as an integrated frequency multiplier, such as a microwave monolithic integrated circuit (MMIC) having an active frequency multiplier therein, e.g., a synchronous oscillator or a BGX7101 available from NXP Semiconductors of San Jose, Calif.

A cross-section of the slot antenna and frequency multiplier along the line A-A of FIG. 1 is shown in FIG. 2. Here, the metallic substrate 100 is sandwiched between two dielectric layers 202 and 204. Layer 202, over one major surface of the substrate 100, is an optional layer used to protect the device 108 and the slot 102 from physical damage and moisture. In alternative embodiments, there might be additional layers (not shown) between substrate 100 and the layer 202 or there might be additional layers on the layer 202. In one embodiment, the layer 202 is a silicone-based plastic, a polystyrene, or a polyvinylchloride layer singly or in combination. Layer 202 can be conventionally attached to substrate 100 by well-known techniques.

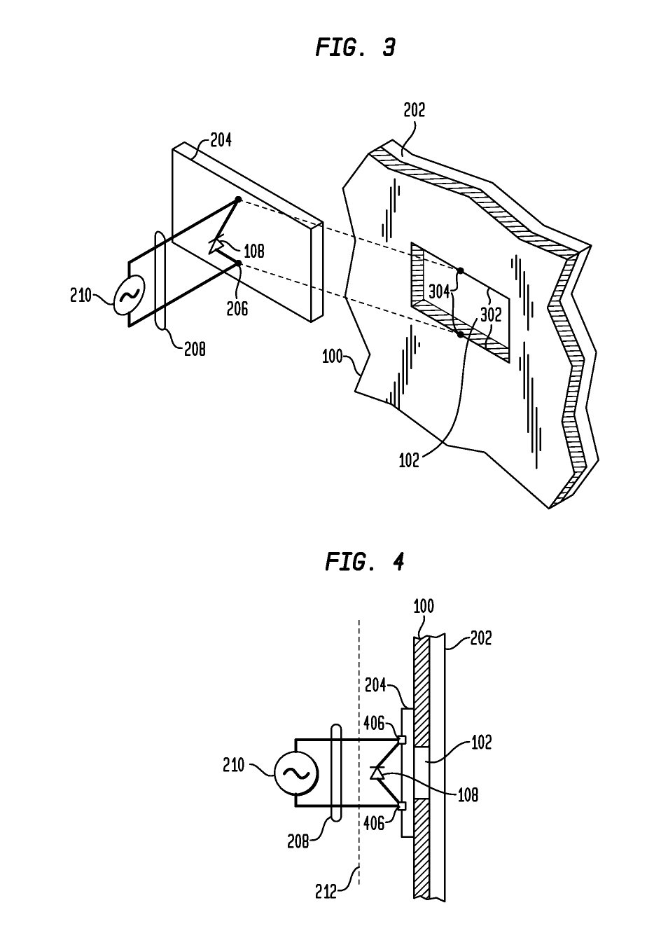

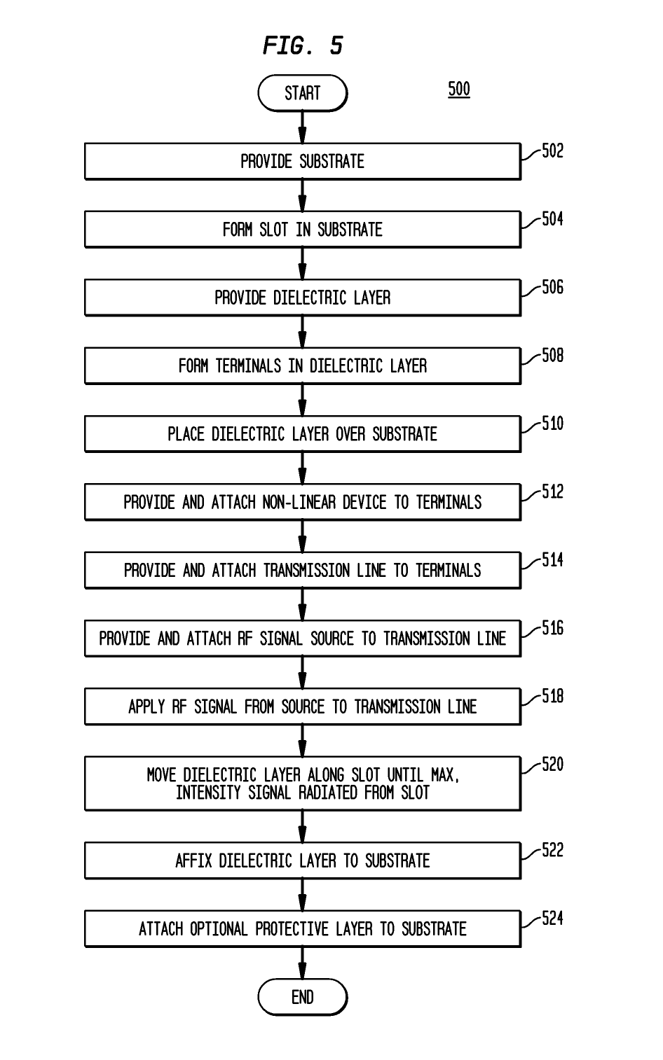

The layer 204, over another major surface of the substrate 100, has terminals 206 therein that are used to electrically connect leads of the device 108 to the sides of the slot 102 as discussed above. As will be illustrated below in connection with FIGS. 3 and 5, the layer 204 might be mechanically movable along the substrate 100 to allow the positioning of the device 108 along the major axis of the slot 102 during manufacture to facilitate tuning the slot/device 108 combination in order to achieve the desired output power therefrom. The layer 204 might also be impervious to moisture. In one embodiment, the layer 204 is a polyimide such as Kapton8 (a registered trademark of E.I du Pont de Nemours and Company, Wilmington, Del., United States). Other suitable polyimides or polymeric materials might be used instead. The layer 204 might provide a surface upon which distributed coupling and matching circuitry can be formed. For example, impedance matching networks to optimize output power can be placed upon the dielectric surface, within the aperture of the slot 102 to transform a source driving impedance to match the slot antenna/non-linear device driving point impedance.

A transmission line 208, shown here as having two conductors, couples a signal source 210 to the device 108. The signal source 210 provides an RF signal having a frequency that is an integral fraction of a desired frequency of the radio frequency signal to be radiated by the slot 102. The device 108 receives the RF signal from the source 210 and multiplies the frequency of the RF signal to the desired frequency for the slot 102 to radiate. For example, if the desired frequency is 60 GHz, then the frequency from the source 210 might be 20 GHz or 30 GHz depending on the amount of frequency multiplication provided by the device 108. In one example, the slot 102 has a length along its major axis 104 of approximately a half wavelength (λ/2) or longer of a RF signal being multiplied by the device 108, and approximately an odd multiple of half wavelength (λ_{O}/2) of the RF signal generated by the device 108 for radiation by slot 102, i.e., N(λ_{O}/2), where N=1, 3, 5, etc. For example and for this embodiment, having the device 108 operate as a frequency tripler (e.g., 20 GHz in, 60 GHz out, making λ₁=3λ_{O}) results in the length of the slot to be N(λ_{O}/2), where N=3, 5, etc.

The signal source 210 might be a implemented on an integrated circuit, such as an IEEE 802.11-compliant device, or other semiconductor device capable of providing an RF signal with sufficient power at the subharmonic of the desired frequency. With an integrated circuit signal source 210, the transmission line 208 might be a strip-line transmission line as known in the art or might simply be two or more bond wires from the integrated circuit to the terminals 206.

A conductive shield 212, such as a plate or an open-ended box covering at least the slot 102 and device 108, might be placed behind layer 204 to enhance radiation from the slot in direction of the layer 202 into free space and to protect any circuitry behind the shield from RF radiation. Preferably, the conductive shield is constructed of any suitable electromagnetic shielding material.

FIG. 3 is a simplified diagram of the structure shown in FIGS. 1 and 2 illustrating the constitute parts thereof. Here, the dielectric layer 204 is shown separate from the substrate 100. As shown, the layer 204 might be large enough to cover the entire slot 102. Terminals 206 are positioned so that they can be electrically connected to the edges 302 of the slot 102. As will be discussed in more detail in connection with FIG. 5, the combination of the slot antenna and the frequency multiplier (non-linear device 108) is tuned by mechanically moving or sliding the dielectric layer 204 along the slot until the desired output signal, in one embodiment, meets a desired output power or, in another embodiment, peaks in output power. Then the contacts 206 are conventionally mechanically attached, e.g., bonded, to the slot edges 302 at points 304.

FIG. 4 is an alternative embodiment of the invention in which the non-linear device 108 is not electrically connected to the edges of the slot, allowing for DC biasing of the non-linear device 108. This embodiment is similar to that shown in FIG. 2 but instead of terminals 206 (FIG. 2) contacting the substrate 100, terminals 406 are conventionally located in or on the layer 204 and do not reach the substrate 100. Otherwise, the function of terminals 406 is the same as terminals 206. In an alternative embodiment, there are other conductors (e.g., a dipole, not shown) formed on the layer 204 and in contact with terminals 406 to enhance coupling of the frequency-multiplied RF signal from the device 108 to the slot 102 for radiation thereby. The slot has a length along its major axis of approximately odd multiples of half wavelength of a radio frequency signal to be radiated by the slot 102, i.e., N(λ/2), where N=1, 3, 5, etc.

In one embodiment, the signal source 210 (FIG. 2-4) might be modulated using, for example, gaussian minimum shift keying, frequency shift keying, or on-off keying for data communication, or with amplitude modulation or frequency modulation for analog (e.g., voice) communication.

FIG. 5 is an exemplary process 500 used to form the integrated slot antenna and frequency multiplier. Starting with step 502, a substrate is provided such that, in step 504, a slot is conventionally formed therein by milling, stamping, etching, or other similar process and in accordance with the embodiments disclosed above. Next, in step 506, the dielectric layer 204 is provided and in step 508, terminals 206 are formed therein by, for example, a photolithographic process or by mechanically using a punch and then filling the holes by electroplating or electroless plating. In step 510, the dielectric layer 204 is placed on a first major surface of the substrate 100 and over the slot 102 (FIG. 1). Next, in step 512, the non-linear device 108 is provided and then attached to the terminals 206. In step 514, the transmission line 208 is provided and attached to the terminals 206. In step 516, the RF signal source 210 is provided and attached to the transmission line 208. Then in step 518, the RF signal source applies a RF signal to the transmission line and, in step 520, the dielectric layer is mechanically displaced along the major axis 104 of the slot 102 until a radio frequency signal of the desired frequency is achieved and radiated from the slot 102 at a desired intensity (e.g., maximum intensity). In step 522, the dielectric layer is fixed in place by optionally bonding the terminals 206 in the dielectric layer 204 to the first major surface of the conducting substrate or by using adhesive to keep the layer 204 in place in the embodiment where the terminals 206 are not bonded to the substrate 100 (FIG. 4). Next, the optional protective layer 202 is attached over a second major surface of the substrate 100 in step 524, completing the integrated slot antenna and frequency multiplier.

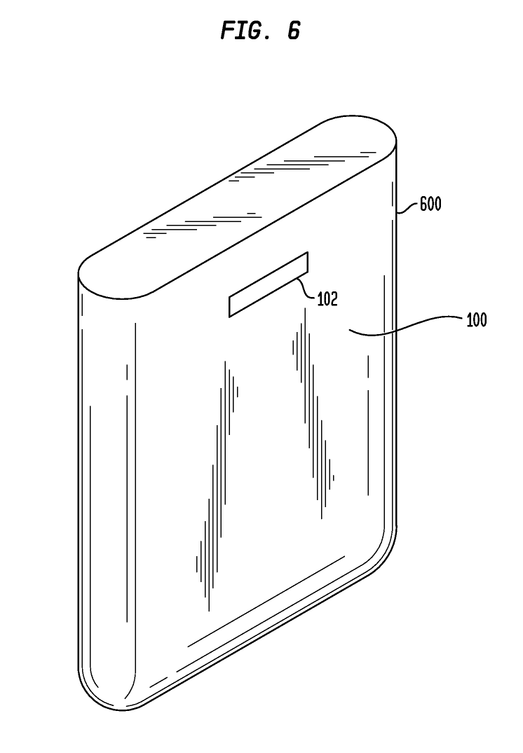

FIG. 6 illustrates an exemplary wireless terminal 600, such as a “smartphone” or the like, having a slot antenna 102 in the substrate 100. A layer (not shown), similar to layer 204 in FIGS. 2-4 might be added to protect the slot from enviromental damage. The slot 102 is illustrated to be on the back of the wireless terminal 600 but might be placed at the top or bottom thereof. Further, more than one slot might be provided for, each for a different frequency band.

While embodiments have been described with respect to circuit functions, the embodiments of the present invention are not so limited. Possible implementations, either as a stand-alone antenna/frequency multiplier or embedded with other circuit functions, may be embodied in or part of a single product, such as a wireless terminal, or part of a larger system, such as part of a communication system infrasture, etc. but are not limited thereto. Such embodiments might be employed in conjunction with, for example, a digital signal processor, microcontroller, field-programmable gate array, application-specific integrated circuit, radio transceiver, frequency synthesizer, or general-purpose computer. It is understood that embodiments of the invention are not limited to the described embodiments, and that various other embodiments within the scope of the following claims will be apparent to those skilled in the art.

It is understood that various changes in the details, materials, and arrangements of the parts which have been described and illustrated in order to explain the nature of this invention may be made by those skilled in the art without departing from the scope of the invention as expressed in the following claims.

1. An apparatus comprising:
a conducting substrate having a slot therein, a first major surface, and a second major surface, the slot having a major axis and a minor axis;
a non-linear device having two terminals, the terminals coupled between opposing edges of the slot on the first major surface and aligned with the minor axis.

2. The apparatus of claim 1 further comprising:
a dielectric layer disposed on the first major surface between the non-linear device and the first major surface of the conducting substrate; and
a plurality of terminals embedded in the dielectric layer, the terminals connecting the non-linear device terminals to the opposing edges of the slot on the first major surface and aligned with the minor axis.

3. The apparatus of claim 2 wherein the dielectric layer is a polyimide film and the conducting substrate is a metal sheet.

4. The apparatus of claim 1 further comprising:
a transmission line coupled to both terminals of the non-linear device.

5. The apparatus of claim 4 further comprising:
a radio frequency signal source coupled to the transmission line and distal from the non-linear device, the source configured to provide a radio frequency signal having a frequency that is an integral fraction of a desired frequency of radio frequency signal to be radiated by the slot.

6. The apparatus of claim 4 wherein the non-linear device has a length, the minor axis has a length approximately equal to the length of the non-linear device, and the major axis has a length approximately one-half that of the wavelength of the provided radio frequency signal.

7. The apparatus of claim 6 wherein the slot has a midpoint along the major axis thereof and the non-linear device is offset from the midpoint of the slot.

8. The apparatus of claim 1 further comprising:
a non-conductive layer disposed proximate the second major surface of the conducting substrate.

9. The apparatus of claim 8 wherein the non-conductive layer is a protective layer impervious to moisture and is sufficiently rigid to protect the non-linear device from physical damage.

10. The apparatus of claim 1 wherein the non-linear device is selected from one or more of the group consisting of: semiconductor junction diode, Schottky diode, anti-parallel diodes, step-recovery diode, PIN diode, an integrated frequency multiplier, and a synchronous oscillator.

11. A wireless terminal comprising:
a frequency multiplier and integrated slot antenna in accordance with claim 1.

12. An apparatus comprising:
a conducting substrate having a slot therein, a first major surface, and a second major surface, the slot having a major axis and a minor axis;
a dielectric layer disposed on the first major surface of the substrate;
a plurality of terminals disposed on a surface of the dielectric layer opposite the substrate;
a non-linear device having a major axis and two terminals connecting to corresponding terminals on the dielectric layer;
wherein the non-linear device is proximate the slot and the non-linear device is substantially aligned with the minor axis.

13. The apparatus of claim 12 wherein the dielectric layer is a polyimide film and the conducting substrate is a metal sheet.

14. The apparatus of claim 13 further comprising:
a transmission line coupled to both terminals of the non-linear device.

15. The apparatus of claim 14 further comprising:
a radio frequency signal source coupled to the transmission line and distal from the non-linear device, the source configured to provide a radio frequency signal having a frequency that is an integral fraction of a desired frequency of a radio frequency signal to be radiated by the slot.

16. The apparatus of claim 15 wherein the non-linear device has a length along the major axis thereof, the minor axis of the slot has a length approximately equal to the length of the non-linear device, and the major axis of the slot has a length approximately one-half that of the wavelength of the desired radio frequency signal.

17. The apparatus of claim 16 wherein the slot has a midpoint along the major axis thereof and the non-linear device is offset from the midpoint of the slot.

18. The apparatus of claim 12 further comprising:
a non-conductive layer disposed over the second major surface of the conducting substrate.

19. The apparatus of claim 18 wherein the non-conductive layer is a protective layer impervious to moisture and is sufficiently rigid to protect the non-linear device from physical damage.

20. The apparatus of claim 12 wherein the non-linear device is selected from one or more of the group consisting of: semiconductor junction diode, Schottky diode, anti-parallel diodes, step-recovery diode, PIN diode, an integrated frequency multiplier, and a synchronous oscillator.

21. The apparatus of claim 12 wherein the plurality of terminals, disposed on a surface of the dielectric layer opposite the substrate, penetrate the dielectric layer and connect the non-linear device terminals to the opposing edges of the slot on the first major surface and aligned with the minor axis of the slot.

22. A method comprising the steps of:
providing a conducting substrate having a first major surface and a second major surface;
forming a slot in the conducting substrate from first major surface to the second major surface, the slot having a major axis and a minor axis;
providing a non-linear device having two terminals; and
coupling the terminals of the non-linear device between opposing edges of the slot on the first major surface and aligned with the minor axis.

23. The method of claim 22 further comprising the steps of:
forming a dielectric layer on the first major surface between the non-linear device and the first major surface of the conducting substrate;
forming a plurality of terminals in the dielectric layer, the terminals for connecting the non-linear device terminals to the opposing edges of the slot; and
placing the dielectric layer on the first major surface of the substrate and over the slot.

24. The method of claim 23 further comprising the steps of:
providing a transmission line; and
coupling the transmission line to both terminals of the non-linear device.

25. The method of claim 24 further comprising the steps of:
providing a radio frequency signal source;
coupling the radio frequency signal source to the transmission line distal from the non-linear device;
wherein the source configured to provide a radio frequency signal having a frequency that is an integral fraction of a desired frequency of a radio frequency signal to be radiated by the slot.

26. The method of claim 25 wherein the dielectric layer is in contact with the first major surface of the substrate and is slidable thereon, the method further comprising the steps of:
applying, by the radio frequency signal source, the radio frequency signal to the transmission line;
moving the dielectric layer along the major axis until the radiated radio frequency signal of the desired frequency has a desired intensity; and
affixing the dielectric layer in place by bonding the terminals in the dielectric layer to the first major surface of the conducting substrate.

27. The method of claim 23 further comprising the step of:
forming a non-conductive layer over the second major surface of the conducting substrate;
wherein the non-conductive layer is a protective layer impervious to moisture and is sufficiently rigid to protect the non-linear device from physical damage.

28. The method of claim 23 wherein the dielectric layer is a polyimide layer, the conducting substrate is a metal sheet, and the non-linear device is selected from one or more of the group consisting of: semiconductor junction diode, Schottky diode, anti-parallel diodes, step-recovery diode, PIN diode, an integrated frequency multiplier, and a synchronous oscillator.
